(19) United States
(12) Patent Application Publication
(10) Pub. No.: US 2015/0094131 A1
(43) Pub. Date: Apr. 2, 2015

(54) GAME MACHINE

(71) Applicant: OMRON Corporation, Kyoto-shi (JP)

(72) Inventor: Hiroyuki Onitsuka, Gifu (JP)

(21) Appl. No.: 14/470,594

(22) Filed: Aug. 27, 2014

(30) Foreign Application Priority Data
Sep. 30, 2013 (JP) 2013-205596

(51) Int. Cl. G07F 17/32; G07F 17/34

(52) U.S. Cl. CPC G07F 17/3213; G07F 17/34
USPC 463/20

(57) ABSTRACT

A game machine has an operation unit that accepts an operation from a player, having a display section, an operation section disposed on a screen of the display section, a support section that rotatably supports the operation section such that the operation section can be pressed toward the display section, at least one rotational operation sensor that outputs a signal corresponding to a rotational operation on the operation section, and at least one pressing operation sensor that outputs a signal corresponding to a pressing operation on the operation section, and a control section that causes the display section to change a screen image to be displayed by the display section.

### CROSS-REFERENCE TO RELATED APPLICATIONS

This Nonprovisional application claims priority under 35 U.S.C. §119 on Patent Application No. 2013-205596 filed in Japan on Sep. 30, 2013, the entire contents of which are hereby incorporated by reference.

### BACKGROUND

1. Technical Field

The present invention relates to a game machine having an operation unit.

2. Related Art

Conventionally, there have been game machines so-called slot machines. A slot machine is designed such that a plurality of reels each showing a plural kinds of symbols around them are spun and stopped to show a winning combination on the basis of a matching pattern of symbols and the kinds of the matched symbols that are displayed along a particular line when the reels are stopped, and a prize is given according to the determined winning combination and the number of bets.

Game machines, including not only such slot machines but also other examples such as pachinko machines and arcade game machines, have a plurality of operation buttons mounted thereon. In many cases, such operation buttons are each used as a single-function button via which a predetermined single instruction is inputted. For example, in a case of a slot machine, a LINE button (button for determining a line to which a prize is given), a BET button (button for determining the number of bets), a SERVICE button (button for calling a staff), and a COLLECT button (button for settlement) are provided on an operation panel.

However, recently, there has been known game machines having an operation unit with a plurality of functions. For example, Patent Literature 1 discloses a game machine having a dialing operation section of a circular shape and a pressing operation section of a cylindrical shape. The pressing operation section is contained in a circle of the dialing operation section. This configuration enables a player to make a dialing operation and a pressing operation via a single operation unit.

### CITATION LIST

### Patent Literatures

### Patent Literature 1

Japanese Patent Application Publication, Tokukai, No. 2012-110372 (published on Jun. 14, 2012)

### SUMMARY

However, in the technique of Patent Literature 1, a screen for urging a player to make an operation on an operation unit is provided separately from the operation unit. Consequently, the player is required to move his/her eyes between the screen and the operation unit in order to make an operation on the operation unit. This results in inconvenience of the player. Besides, although the technique of Patent Literature 1 can realize a dialing operation function and a pressing operation function, the technique does not consider a presentation function of the operation unit itself. This results in a low presentation effect.

A game machine according to one or more embodiments of the present invention has an operation unit with high operability and a high presentation effect.

A game machine according to one or more embodiments of the present invention is a game machine, including: an operation unit via which a player enters an operation, the operation unit including: a display section; an operation section provided on a screen of the display section; a support section for supporting the operation section in such a manner that the operation section is rotatable and the operation section is capable of being pressed toward the display section; at least one rotational operation sensor for outputting a signal corresponding to a rotational operation on the operation section; and at least one pressing operation sensor for outputting a signal corresponding to a pressing operation on the operation section, and a control section for causing the display section to change a screen image to be displayed by the display section, in accordance with at least one of (i) a rotational operation detected based on the signal outputted from each of the rotational operation sensors, and (ii) a pressing operation detected based on the signal outputted from each of the pressing operation sensors.

With one or more embodiments of the present invention, it may be possible to provide a game machine having an operation unit with high operability and a high presentation effect.

### BRIEF DESCRIPTION OF DRAWINGS

FIGS. 1(a)-1(b) are perspective views of a slot machine in accordance with one or more embodiments of the present invention.

FIG. 2 is a perspective view of an operation unit included in the slot machine illustrated in FIGS. 1(a)-1(b).

FIG. 3 is an exploded perspective view of the operation unit illustrated in FIG. 2.

FIG. 4 is an exploded perspective view of an operation section included in the operation unit illustrated in FIG. 2.

FIG. 5 is a perspective view illustrating a frame section included in the operation unit illustrated in FIG. 2.

FIG. 6 is an exploded perspective view of a lower cover section included in the operation unit illustrated in FIG. 2.

FIG. 7 is an exploded perspective view of a display section included in the operation unit illustrated in FIG. 2.

FIG. 8 is a cross sectional view of the operation unit in a case where a pressing operation is not made on the operation section.

FIG. 9 is a perspective view illustrating a positional relationship among an operation-detecting member of the operation section and first to third sensors of the lower cover section, in a case where a pressing operation is not made on the operation section.

FIG. 10 is a view illustrating a change in output signals of the first to third sensors of the lower cover section in a case where a rotational operation is made on the operation section.

FIG. 11 is a cross sectional view of the operation unit in a case where a pressing operation is made on the operation section.

FIG. 12 is a perspective view illustrating a positional relationship among the operation-detecting member of the operation section and the first to third sensors of the lower cover section, in a case where a pressing operation is made on the operation section.

FIG. 13 is a view illustrating output signals of the first to third sensors of the lower cover section in a case where a pressing operation is made on the operation section.

FIG. 14 is a block diagram illustrating an internal configuration regarding control of presentation in the slot machine illustrated in FIG. 1.

FIG. 15 is a view illustrating examples of screen images displayed by the operation unit illustrated in FIG. 2.

FIGS. 16(a)-16(h) are views illustrating other examples of screen images displayed by the operation unit illustrated in FIG. 2.

FIG. 17 is a block diagram illustrating an internal configuration of a game machine in accordance with first modification.

### DETAILED DESCRIPTION

Embodiments of the present invention will be described below with reference to the drawings. In embodiments of the invention, numerous specific details are set forth in order to provide a more thorough understanding of the invention. However, it will be apparent to one of ordinary skill in the art that the invention may be practiced without these specific details. In other instances, well-known features have not been described in detail to avoid obscuring the invention.

### (Overall Configuration of Slot Machine)

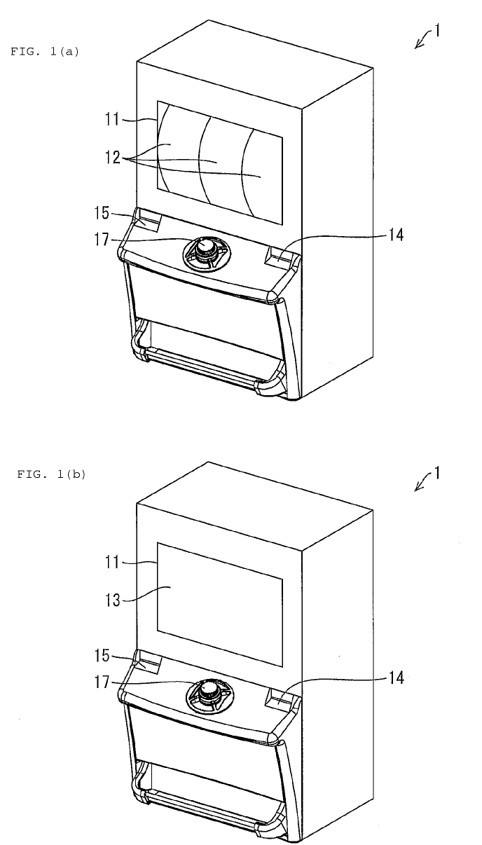

FIGS. 1(a)-1(b) are perspective views illustrating a configuration of a slot machine 1 which is a game machine in accordance with one or more embodiments of the present invention. Below, a description will be made as to a slot machine which is an example of a game machine according to one or more embodiments of the present invention. However, the present invention is not limited to a slot machine, and may be applied to game machines in other forms, such as pachinko machines and various other game machines.

As illustrated in FIGS. 1(a)-1(b), the slot machine (game machine) 1 includes a reel display region 11, a paper money slot 14, a thicket issue slot 15, an operation unit 17 etc.

The reel display region 11 is a region where a plurality of reels are displayed. These reels are spun in response to an operation of a player. A winning combination is determined according to symbols shown on the reels when the reels are stopped, and a prize is given to the player according to the winning combination. The reel display region 11 may be arranged such that a plurality of reels 12 themselves are provided at the reel display region 11 as illustrated in FIG. 1(a), or may be arranged such that a liquid crystal display (LCD) device 13 for displaying an image corresponding to reels on a screen is provided at the reel display region 11 as illustrated in FIG. 1(b).

The paper money slot 14 receives a paper money to be input in order for a player to play a game. The thicket issue slot 15 issues a settlement thicket when the player ends the game.

The operation unit 17 receives an operation from a player. In one or more embodiments of the present invention, the operation unit 17 receives various operation instructions such as an instruction for determining the number of bets when a player plays a slot game, an instruction for determining a line to which a prize is to be given, an instruction for starting rotation of the reels, an instruction for calling a staff, and an instruction for making settlement. Furthermore, in a case where a mini game (e.g. roulette game) different from the slot game, which is offered as a bonus game, a challenge game etc., is played on the slot machine 1, the operation unit 17 may be configured to receive an instruction for an operation on the mini game. Furthermore, in a case where the reel display region 11 includes the liquid crystal display device 13 as illustrated in FIG. 1(b) and the liquid crystal display device 13 can display various information, the operation unit 17 may be configured to receive an operation to display various information.

In one or more embodiments of the present invention, the operation unit 17 has a rotational operation function (dialing operation function) which enables a player to enter an instruction via a rotational operation, a pressing operation function (button operation function) which enables a player to enter an instruction via a pressing operation, a display function for displaying various information (e.g. information for urging a player to make an operation) to a player, and a touching operation function which enables a player to make an operation on a touch panel.

Behaviors of individual sections of the slot machine 1 are controlled by a control section (not illustrated in FIGS. 1(a)-1(b)) included in the slot machine 1. The control section includes, for example, a CPU (Central Processing Unit) or the like, and controls the behaviors of individual sections of the slot machine 1 on the basis of (i) results of detections by sensors provided in the slot machine 1, (ii) an operation instruction from a player to the operation unit 17, (iii) a program and various data stored in storage means (not illustrated) such as a ROM, and/or (iv) the like.

For example, the control section receives, from the operation unit 17, a signal corresponding to an operation (rotational operation, pressing operation, and touching operation) by a player on the operation unit 17, and controls the behaviors of individual sections in accordance with the signal.

### (Schematic Configuration of Operation Unit)

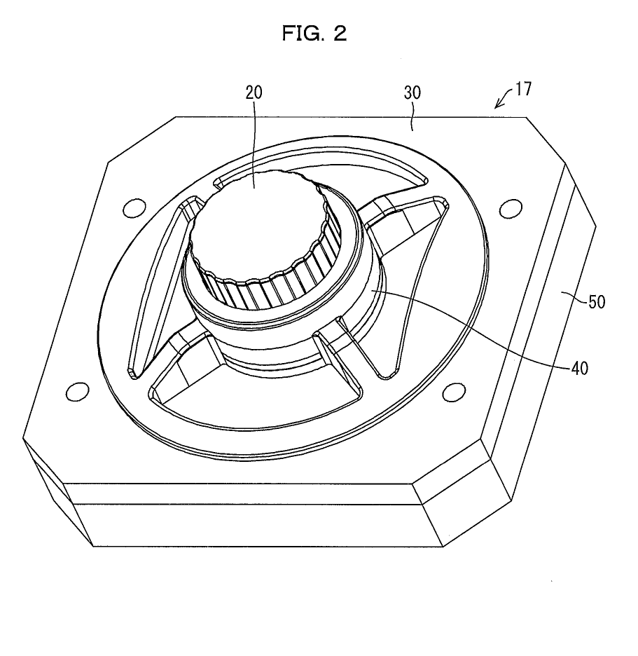

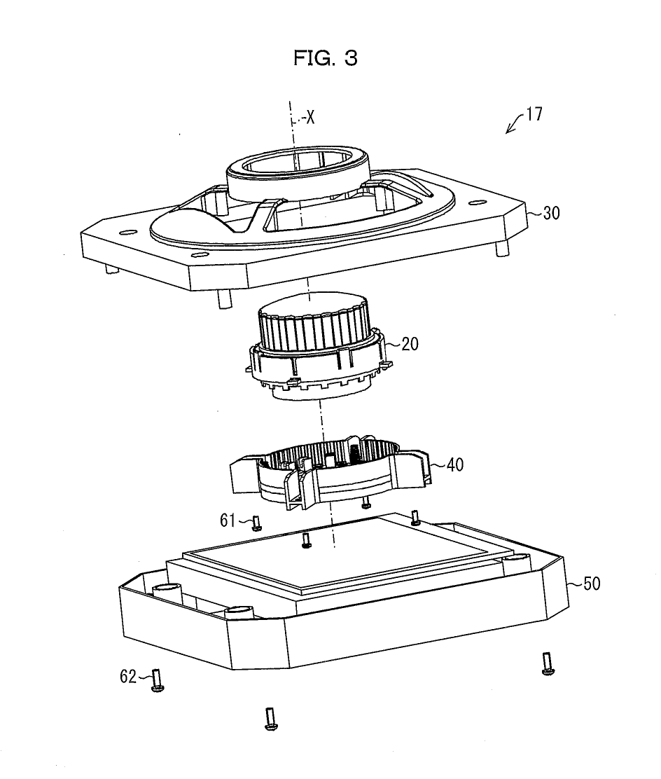

FIG. 2 is a perspective view of the operation unit 17. FIG. 3 is an exploded perspective view of the operation unit 17.

As illustrated in FIGS. 2 and 3, the operation unit 17 includes an operation section 20, a frame section 30, a lower cover section 40, and a display device 50.

The operation section 20 has substantially a columnar shape. The frame section 30 and the lower cover section 40 sandwich the operation section 20 from above and below, respectively, along an axis X of the substantially columnar shape of the operation section 20, and support the operation section 20 by being fixed to each other via screws 61. It should be noted that the frame section 30 and the lower cover section 40 support the operation section 20 in such a manner that the operation section 20 is rotatable around the axis X, and the operation section 20 can be pressed toward the lower cover section 40 along the axis X.

The display device 50 has substantially a rectangular shape. The frame section 30 is attached to the display device 50 via screws 62 in such a manner that the lower cover section 40 is positioned between the frame section 30 and the display device 50. Here, the frame section 30 is attached to the display device 50 in such a manner that the axis X of the operation section 20 supported by the frame section 30 extends in a direction normal to a screen of the display device 50 and the operation section 20 is positioned at a center of the screen of the display device 50. Consequently, the operation section 20 is rotatable around an axis extending in the direction normal to the screen of the display device 50 and can be pressed toward the screen of the display device 50.

The following description will discuss configurations of the operation section 20, the frame section 30, the lower cover section 40, and the display device 50 in details.

### (Configuration of the Operation Section)

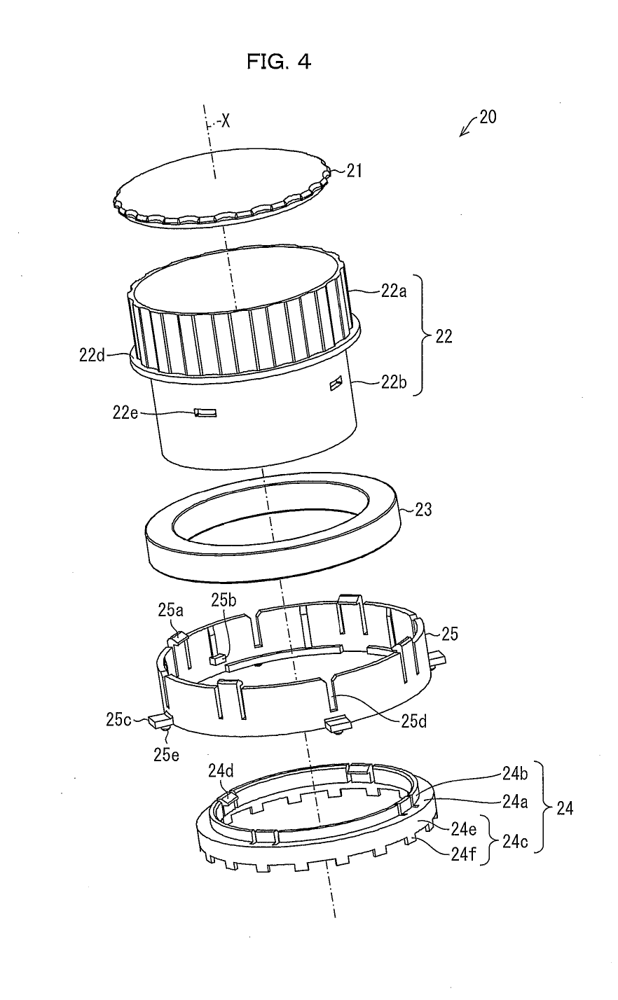

FIG. 4 is an exploded perspective view of the operation section 20. As illustrated in FIG. 4, the operation section 20 includes a lens 21, a main body 22, a bearing 23, a bearing fixing section 24, and a case 25.

The main body 22 has a hollow cylindrical shape, and is made up of a first cylindrical section 22a and a second cylindrical section 22b which is smaller in diameter than the first cylindrical section 22a. The first cylindrical section 22a and the second cylindrical section 22b are coupled with each other in a direction of the axis X. A lower end of the first cylindrical section 22a (an end of the first cylindrical section 22a which end is closer to the second cylindrical section 22b) is provided with a flange section 22d. An external circumferential surface of the second cylindrical section 22b has a plurality of engaging holes 22e which are provided along a circumferential direction. The engaging holes 22e are provided in such a manner that a distance between each of the engaging holes 22e and the flange section 22d is substantially equal to a height of the bearing 23.

The lens 21 is a cover which covers an upper opening end of the first cylindrical section 22a which end is positioned on an upper side of the main body 22. The lens 21 is made of a transparent material.

The bearing 23 has an internal diameter which is a little larger than an external diameter of the second cylindrical section 22b of the main body 22. The second cylindrical section 22b is inserted into the bearing 23.

The case 25 has a cylindrical shape having an internal diameter which is a little larger than an external diameter of the bearing 23. The case 25 has, at its upper end, a plurality of upper protrusions 25a which protrude inwardly of the case 25, and has, on its inner circumferential surface, a plurality of lower protrusions 25b which protrude inwardly of the case 25, and has, at its lower end, a plurality of external protrusions 25c which protrude outwardly of the case 25, and has a plurality of grooves 25d which are parallel to the axis X. Each of the external protrusions 25c has, on its lower surface, a convex section 25e which protrudes downward.

A distance between the upper protrusion 25a and the lower protrusion 25b in the X axis direction is substantially equal to the height of the bearing 23. The bearing 23 is put between the upper protrusions 25a and the lower protrusions 25b. Consequently, the case 25 can support the bearing 23.

The bearing fixing section 24 is a member which causes a relative positional relationship between the main body 22 and the bearing 23 along the axis X to be constant. That is, the bearing fixing section 24 prevents the main body 22 from dropping out of the bearing 23. The bearing fixing section 24 includes a base section 24a, a first wall section 24a, and an operation-detecting member 24c.

The base section 24a has a ring shape whose upper and lower surfaces are flat, and whose internal diameter is a little larger than the external diameter of the second cylindrical section 22b of the main body 22. The first wall section 24b is provided on an upper surface of the base section 24a so as to be positioned at an end closer to an internal circumference of base section 24a and so as to be uniform in a circumferential direction of the base section 24a. The first wall section 24b has, at its upper end, a plurality of engaging pawls 24d which protrude inwardly.

The operation-detecting member 24c is a member for detecting a rotational operation and a pressing operation on the main body 22, and has a ring shape with a predetermined radius R. The operation-detecting member 24c includes a second wall section 24e and a plurality of protrusions 24f. The second wall section 24e is provided on a lower surface of the base section 24a so as to be positioned at an end closer to an external circumference of the base section 24a and so as to be uniform in the circumferential direction of the base section 24a. The plurality of protrusions 24f are provided on a lower surface of the second wall section 24e so as to protrude downward from the lower surface of the second wall section 24e and so as to be along a circumferential direction of the second wall section 24e with a certain interval therebetween.

The second cylindrical section 22b of the main body 22 is inserted into the bearing 23 until an upper surface of the bearing 23 touches the flange section 22d. In this state, the second cylindrical section 22b is further inserted into the bearing fixing section 24, and the engaging pawls 24d of the bearing fixing section 24 are put in the engaging holes 22e of the second cylindrical section 22b. Consequently, a relative positional relationship between the bearing 23 and the main body 22 in a direction along the axis X (upper and lower directions) can be made constant.

With the arrangement, the main body 22 is integral with the lens 21 and the bearing fixing section 24, and is rotatable via the bearing 23 with respect to the case 25. It should be noted that the main body 22 is fixed to the bearing 23 via the bearing fixing section 24 in the upper and lower directions. Consequently, when the main body 22 is pressed downward along the direction of the axis X of the main body 22, the bearing 23 and the case 25 are also pressed downward together with the main body 22.

Furthermore, since the upper opening end of the main body 22 is covered with the transparent lens 21, it is possible to view a part below the main body 22 through the lens 21 when viewing the operation section 20 from above.

### (Configuration of the Frame Section)

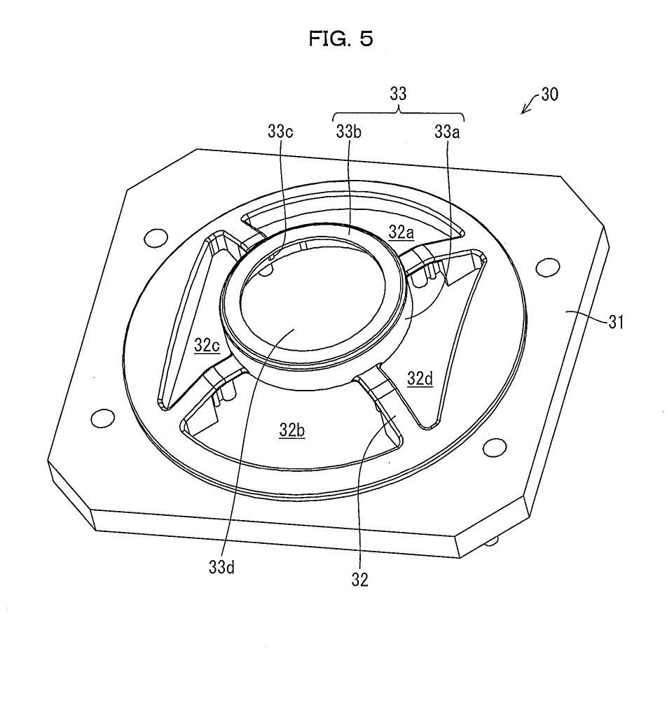

FIG. 5 is a perspective view illustrating a configuration of the frame section 30. As illustrated in FIG. 5, the frame section 30 includes an upper cover section 33 having a ring shape, a dividing section 32 which is provided around the upper cover section 33 and which abuts on a part of an external circumference of the upper cover section 33, and a base section 31 having a rectangular plate shape which is provided around the dividing section 32 and which abuts on an external circumference of the dividing section 32.

The upper cover section 33 is a member for supporting the operation section 20 from above, and includes a cylindrical section 33a and a ring section 33b having a plate shape.

An internal diameter of the cylindrical section 33a is a little larger than an external diameter of the case 25 of the operation section 20 (except for the external protrusions 25c). The cylindrical section 33a has, on its internal circumferential surface, a plurality of ribs 33c which extend in a direction of an axis of the cylindrical section 33a. The ribs 33c are positioned in such a manner as to respectively face the grooves 25d of the case 25 when the operation section 20 is inserted into the cylindrical section 33a. Consequently, when the operation section 20 is inserted into the cylindrical section 33a, the ribs 33c respectively engage with the grooves 25d of the case 25 in such a manner that the ribs 33c are slidable only in the axis direction. Consequently, the case 25 cannot rotate with respect to the cylindrical section 33a. The operation section 20 is slidable in the direction of the axis X with respect to the cylindrical section 33a.

The ring section 33b has an external diameter substantially equal to that of the cylindrical section 33a, and an external circumference of the ring section 33b abuts on an upper end of the cylindrical section 33a. The ring section 33b has an internal diameter which is a little larger than an external diameter of the first cylindrical section 22a of the main section 22 included in the operation section 20. Consequently, when the first cylindrical section 22a is inserted into an opening 33d surrounded by the internal circumference of the ring section 33b from below the opening 33d, the flange section 22d provided on the first cylindrical section 22a touches the ring section 33b. That is, the ring section 33b has a function for regulating an upward slide of the operation section 20.

The dividing section 32 abuts on the upper cover section 33 and the base section 31 in such a manner that the dividing section 32 supports the upper cover section 33 and divides a region between the upper cover section 33 and the base section 31 into a plurality of regions. In one or more embodiments of the present invention, the dividing section 32 divides the region between the upper cover section 33 and the base section 31 into four opening regions (first opening region 32a, second opening region 32b, third opening region 32c, and fourth opening region 32d). The first opening region 32a, the second opening region 32b, the third opening region 32c, and the fourth opening region 32d are used for a player to touch the display device 50 positioned below the frame section 30, as described later. For this purpose, the first opening region 32a, the second opening region 32b, the third opening region 32c, and the fourth opening region 32d each have a shape which allows a player to insert a finger thereinto. It should be noted that the dividing section 32 in one or more embodiments of the present invention divides the aforementioned region in such a manner that the first opening region 32a, the second opening region 32b, the third opening region 32c, and the fourth opening region 32d provide a player with different operability when the player touches the display device 50 through the first opening region 32a, the second opening region 32b, the third opening region 32c, and the fourth opening region 32d, respectively. Specifically, as illustrated in FIG. 5, the dividing section 32 divides the aforementioned region in such a manner that each of the third opening region 32c and the fourth opening region 32d has a smaller size than that of each of the first opening region 32a and the second opening region 32b. Consequently, the first opening region 32a and the second opening region 32b provide a player with better operability than the third opening region 32c and the fourth opening region 32d when the player makes a touching operation on the display device 50.

### (Configuration of Lower Cover Section)

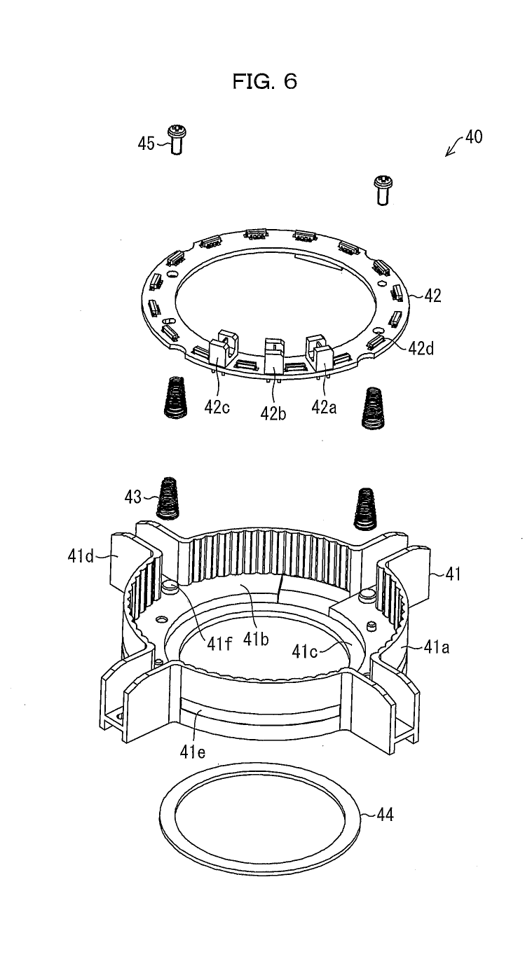

FIG. 6 is an exploded perspective view of the lower cover section 40. The lower cover section 40 includes a cover main body 41, a printed board (PCB: printed circuit board) 42, a plurality of springs 43, and a rubber ring 44.

The cover main body 41 has a shape which overlaps the upper cover section 33 of the frame section 30 and a part of the dividing section 32 supporting the upper cover section 33. The cover main body 41 includes a side wall section 41a having substantially a cylindrical shape, a first bottom section 41b having a ring shape which abuts on a lower end of the side wall section 41a, and a second bottom section 41c having a ring shape which abuts on the first bottom section 41b.

The side wall section 41a has the same diameter as that of the cylindrical section 33a of the upper cover section 33, and includes protrusions 41d which protrude outwardly from portions overlapping a part of the dividing section 32. A part of the side wall section 41a includes a light-transmitting region 41e which transmits light. The light-transmitting region 41e is provided along a circumferential direction of the side wall section 41a.

The first bottom section 41b having a ring shape has an internal diameter which is a little larger than an external diameter of the second cylindrical section 22b of the main body 22 included in the operation section 20. An external circumference of the second bottom section 41c having a ring shape abuts on an internal circumference of the first bottom section 41b. The second bottom section 41c is positioned lower than the first bottom section 41b, thereby forming a “step” with the second bottom section 41c and the first bottom section 41b. The second bottom section 41c has an internal diameter which is substantially equal to that of a lower end of the second cylindrical section 22b of the operation section 20. Consequently, when a player views the operation section 20 from above, the player can view, via the lens 21, a screen image of the display device 50 which screen image is displayed below the operation section 20.

The printed board 42 has a ring shape whose internal diameter and external diameter are substantially equal to those of the first bottom section 41b. A plurality of light emitting sections 42d are provided on the printed board 42 along a circumferential direction with a certain distance between adjacent ones of the light emitting sections 42d. The light emitting section 42d is, for example, an LED (light emitting diode), and may be one that emits light of a single color or one capable of emitting light of multiple colors.

Three sensors (first sensor 42a, second sensor 42b, and third sensor 42c) for detecting presence/absence of an object are provided on the printed board 42 along a circumferential direction with a predetermined distance between adjacent ones of the sensors. The first sensor 42a, the second sensor 42b, and the third sensor 42c are each a photointerrupter which includes a light emitting section and a light receiving section and detects coming/going of an object into/from a space (object-detecting space) between the light emitting section and the light receiving section. The first sensor 42a, the second sensor 42b, and the third sensor 42c are provided on a circumference with a predetermined radius, whose center corresponds to a center of the ring shape formed by the printed board 42. The predetermined radius is determined to be equal to a radius R of the cylindrical shape formed by the operation detecting member 24c of the operation section 20. It is possible to detect a pressing operation and a rotational operation on the operation section 20 on a basis of a relative positional relationship among the first sensor 42a, the second sensor 42b, the third sensor 42c, and the operation-detecting member 24c. This detection process will be detailed later.

The printed board 42 is fixed to an upper surface of the first bottom section 41b via screws 45. Here, the light emitting sections 42d on the printed board 42 face the light-transmitting region 41e of the cover main body 41. Consequently, light emitted from the light-emitting sections 42d is emitted to the outside of the lower cover section 40.

A plurality of springs 43 are inserted between the operation section 20 and the cover main body 41. Convex sections 41f on the first bottom section 41b are inserted into the springs 43 from lower ends of the springs 43. Convex sections 25e on the lower surfaces of the external protrusions 25c provided on the case 25 of the operation section 20 are inserted into the springs 43 from upper ends of the springs 43. Consequently, a relative positional relationship between the operation section 20 and the lower cover section 40 is determined and a bias force of the springs 43 is applied to the operation section 20.

A rubber ring 44 is provided on the lower surface of the second bottom section 41c of the cover main body 41 in order to prevent the lower cover section 40 from making an impact on the screen of the display device 50.

The lower cover section 40 including the aforementioned members is fixed via screws to the frame section 30 in such a way that the first cylindrical section 22a of the operation section 20 is inserted into the upper cover section 33 of the frame section 30. Consequently, the frame section 30 and the lower cover section 40 sandwich the operation section 20 and thus support the operation section 20, in such a way that, when a rotating force around the axis X is applied on the main body 22 of the operation section 20, the main body 22 rotates via the bearing 23. Furthermore, although the operation section 20 is biased toward the frame section 30 (upward) by the springs 43, the operation section 20 is restricted from further moving upward because the flange section 22d of the main body 22 touches the upper cover section 33. When a pressing force is applied to the operation section 20 toward the lower cover section 40 (downward), the springs 43 are compressed, so that the operation section 20 can slide toward the lower cover section 40. Since an internal diameter of the lower opening end (lower end) of the second cylindrical section 22b of the operation section 20 is substantially equal to that of the second bottom section 41c of the lower cover section 40, further pressing the operation section 20 causes the second cylindrical section 22b of the operation section 20 to touch the second bottom section 41c, so that the operation section 20 is restricted from further moving downward.

### (Configuration of Display Device)

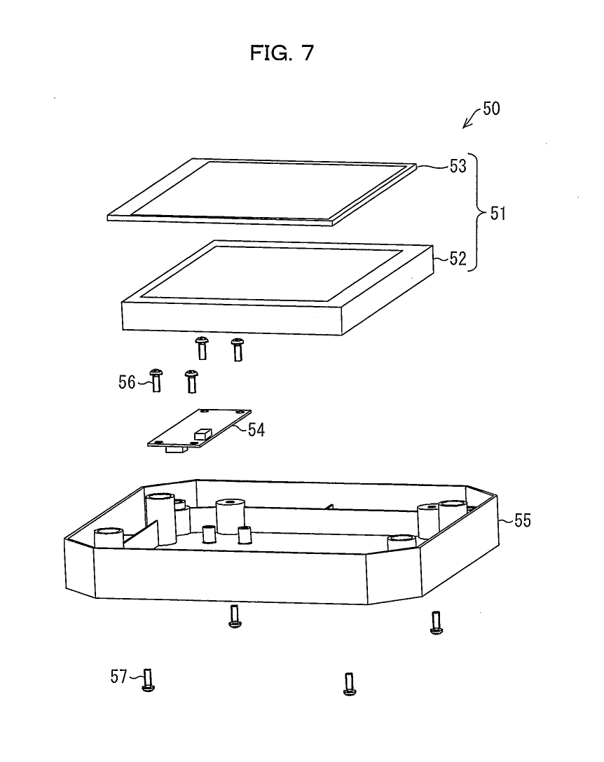

FIG. 7 is an exploded perspective view of the display device 50. As illustrated in FIG. 7, the display device 50 includes a touch panel (display section) 51, a liquid crystal (LC) controlling printed board 54, and a lower case 55.

The touch panel 51 includes a liquid crystal display panel 52 and a touch pad 53, and has a display function and an input function. The touch pad 53 outputs a signal indicative of coordinates of a touched position.

The liquid crystal controlling printed board 54 is a substrate on which a driving circuit for driving the liquid crystal display panel 52 is mounted. The driving circuit changes a screen image of the liquid crystal display panel 52 in accordance with image data supplied from outside.

The lower case 55 has substantially a rectangular parallelepiped shape. The touch panel 51 and the liquid crystal controlling printed board 54 are fixed to the lower case 55 via screws 57 and screws 56, respectively.

### (How to Detect Pressing Operation and Rotational Operation)

The following description will discuss how to detect a pressing operation and a rotational operation on the operation section 20.

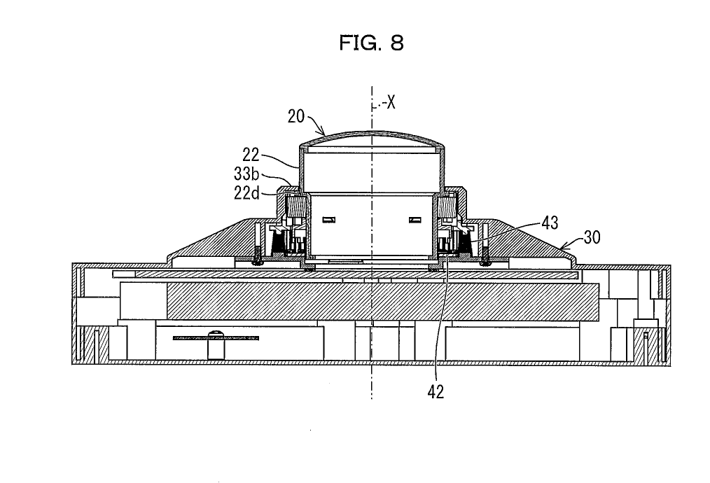

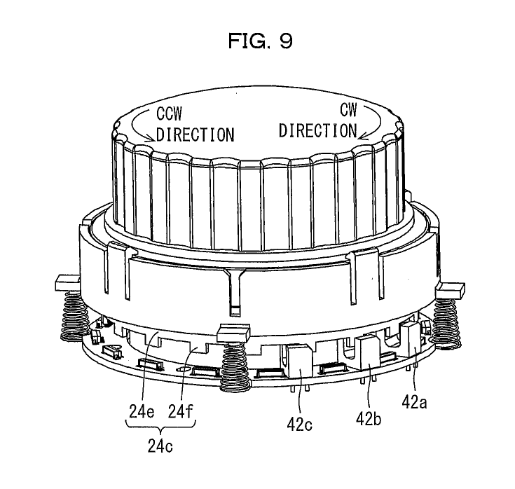

FIG. 8 is a cross sectional view of the operation unit 17 in a case where the pressing operation is not made. FIG. 9 is a perspective view illustrating a positional relationship among the operation-detecting member 24c of the operation section 20 and the first to third sensors 42a to 42c of the lower cover section 40.

The operation section 20, the frame section 30, and the lower cover section 40 are configured such that the axis X of the substantially cylindrical shape formed by the operation section 20 matches with the central axis of the ring shape formed by the printed board 42 when the operation section 20, the frame section 30, and the lower cover section 40 are integrated. A radius of the substantially cylindrical shape formed by the operation-detecting member 24c of the operation section 20 is equal to a radius of the circle on which the first to third sensors 42a to 42c are provided. Accordingly, the operation-detecting member 24c and the first to third sensors 42a to 42c are positioned on the identical circumference when seen from above.

As illustrated in FIG. 8, in a case where the pressing operation on the operation section 20 is not made, the operation section 20 receives an upward force from the springs 43. However, since the flange section 22d of the main body 22 of the operation section 20 touches the ring section 33b of the frame section 30, the position of the operation section 20 in up and down directions is determined. In this state, as illustrated in FIG. 9, only the protrusions 24f of the operation-detecting member 24c can enter an object-detecting space formed by the first to third sensors 42a to 42c. In a case where the rotational operation is made on the operation section 20, the operation-detecting member 24c rotates together with the main body 22, so that the protrusions 24f enter the object-detecting space formed by the first to third sensors 42a to 42c.

As illustrated in FIG. 9, a distance between adjacent ones of the protrusions 24f is shorter than a distance between adjacent ones of the first to third sensors 42a to 42c. Consequently, the first to third sensors 42a to 42c output signals differently depending on where the operation-detecting member 24c rotates.

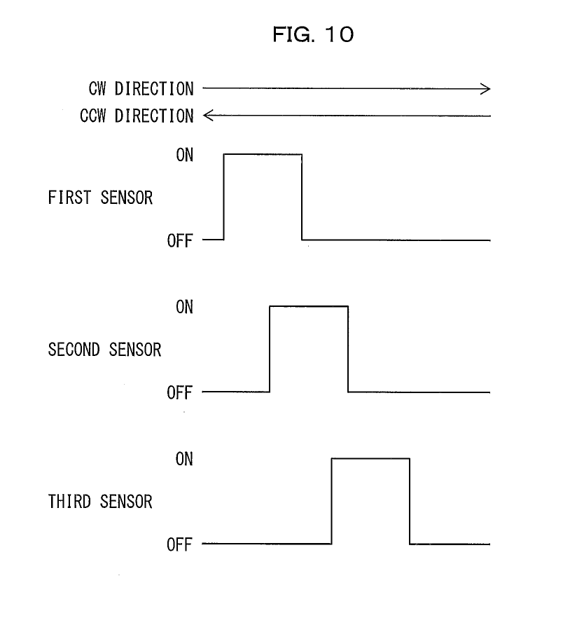

FIG. 10 is a view illustrating a change in output signals of the first to third sensors 42a to 42c. As illustrated in FIG. 10, rotating the operation section 20 clockwise (CW direction in FIG. 9) changes the output signals of the first to third sensors 42a to 42c in the order below. An ON-signal indicates that an object (protrusion 24f in this case) exists in the object-detecting space. An OFF-signal indicates that no object exists in the object-detecting space.
(1) Output signal of the first sensor 42a changes from OFF to ON
(2) Output signal of the second sensor 42b changes from OFF to ON
(3) Output signal of the first sensor 42a changes from ON to OFF.
(4) Output signal of the third sensor 42c changes from OFF to ON
(5) Output signal of the second sensor 42b changes from ON to OFF
(6) Output signal of the third sensor 42c changes from ON to OFF
(1) Output signal of the first sensor 42a changes from OFF to ON
(2) . . .

On the other hand, as illustrated in FIG. 10, rotating the operation section 20 counterclockwise (CCW direction in FIG. 9) changes the output signals of the first to third sensors 42a to 42c in the order below.
(1′) Output signal of the third sensor 42c changes from OFF to ON
(2′) Output signal of the second sensor 42b changes from OFF to ON
(3′) Output signal of the third sensor 42c changes from ON to OFF
(4′) Output signal of the first sensor 42a changes from OFF to ON
(5′) Output signal of the second sensor 42b changes from ON to OFF
(6′) Output signal of the first sensor 42a changes from ON to OFF
(1′) Output signal of the third sensor 42c changes from OFF to ON
(2′) . . .

As described above, the order of switching between ON and OFF of the output signals of the first to third sensors 42a to 42c varies depending on a direction in which the operation section 20 rotates. Accordingly, by monitoring the output signals of the first to third sensors 42a to 42c, it is possible to recognize whether the rotational operation is made or not and in what direction the operation section 20 rotates. Furthermore, by monitoring a length of time required for switching between ON and OFF of the output signals of the first to third sensors 42a to 42c, it is possible to calculate a rotation speed. For example, in a case of a clockwise rotation, it is possible to calculate a rotation speed by measuring a length of time from a time point when the output signal of the third sensor 42c changes from OFF to ON to a time point when the output signal of the first sensor 42a changes from OFF to ON. In a case of a counterclockwise rotation, it is possible to calculate a rotation speed by measuring a length of time from a time point when the output signal of the first sensor 42a changes from OFF to ON to a time point when the output signal of the third sensor 42c changes from OFF to ON.

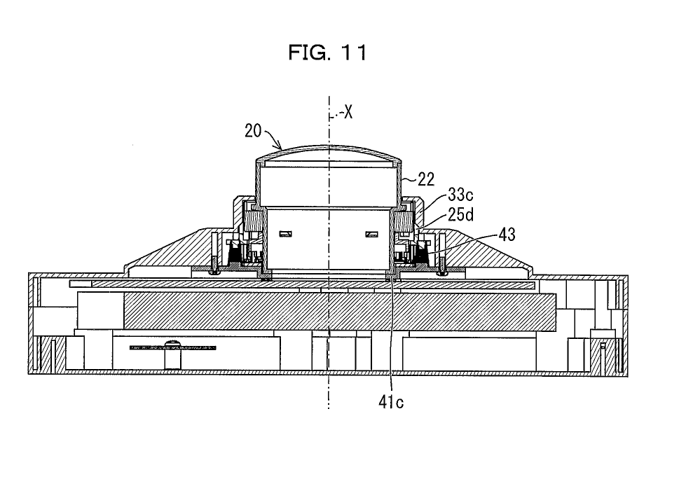

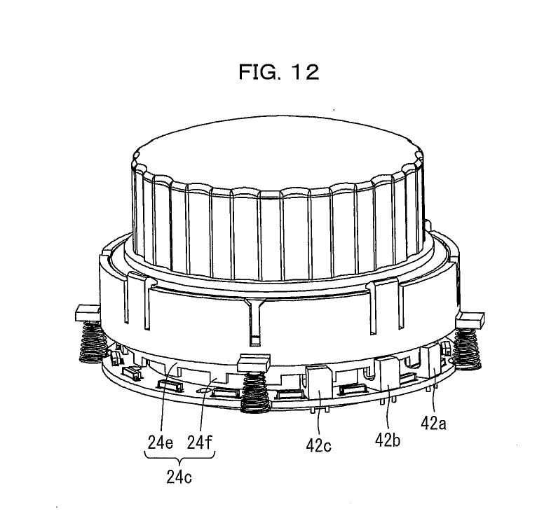

The following description will discuss how to detect a pressing operation. FIG. 11 is a cross sectional view of the operation unit 17 in a case where a pressing operation is made. FIG. 12 is a perspective view illustrating a positional relationship among the operation-detecting member 24c of the operation section 20 and the first to third sensors 42a to 42c of the lower cover section 40.

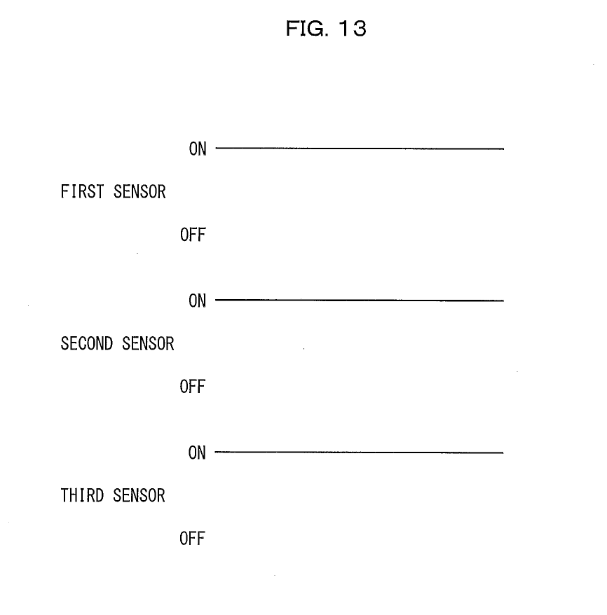

As illustrated in FIG. 11, in a case where the pressing operation is made on the operation section 20, the operation section 20 slides downward against an upward bias force of the springs 43 while the ribs 33c of the upper cover section 33 keep engaging with the grooves 25d of the operation section 20. However, when the lower end of the main body 22 of the operation section 20 touches the second bottom section 41c of the lower cover section 40, the operation section 20 cannot slide downward any more. As illustrated in FIG. 12, the second wall section 24e of the operation-detecting member 24c is designed to have a height which allows the second wall section 24e to go down to the object-detecting space formed by the first to third sensors 42a to 42c in a state where the operation section 20 cannot slide downward any more. The second wall section 24e is provided uniformly along a circumferential direction, as described above. Consequently, as illustrated in FIG. 13, all of the first to third sensors 42a to 42c output ON signals. Therefore, by confirming the output signals of the first to third sensors 42a to 42c, it is possible to recognize that the pressing operation is made.

### (Control of Presentation of Operation Unit)

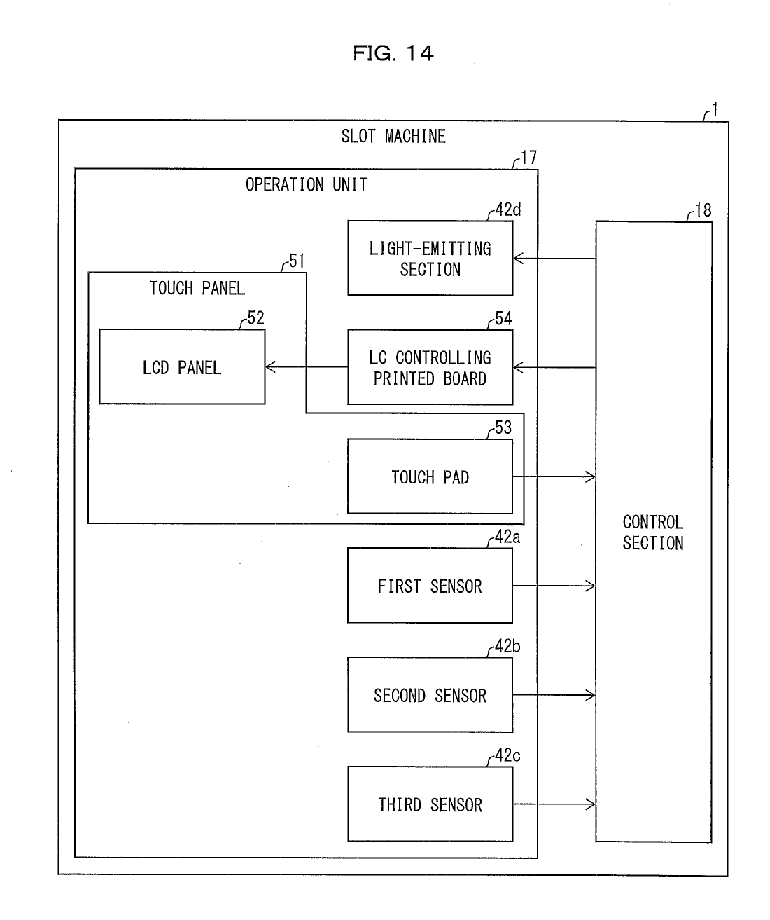

The following description will discuss control of presentation of the operation unit 17 in accordance with one or more embodiments of the present invention. FIG. 14 is a block diagram illustrating an internal configuration regarding control of presentation in the slot machine 1. As illustrated in FIG. 14, the slot machine 1 includes a control section 18.

The control section 18 receives the output signals of the first sensor 42a, the second sensor 42b, the third sensor 42c, and the touch pad 53, and outputs, to the liquid crystal controlling printed board 54, display screen data indicative of an image to be displayed by the liquid crystal display panel 52. The driving circuit mounted on the liquid crystal controlling printed board 54 drives the liquid crystal display panel 52 so that the liquid crystal display panel 52 displays the image indicated by the display screen data received from the control section 18. Consequently, a screen image of the liquid crystal panel 52 changes. This allows the liquid crystal display panel 52 to display various screen images corresponding to an operation by a player and a state of the slot machine 1, thereby enhancing a presentation effect. Besides, the control section 18 may control emission of the light emitting sections 42d of the operation section 20 in accordance with the output signals of the first sensor 42a, the second sensor 42b, the third sensor 42c, and the touch pad 53, thereby further enhancing a presentation effect.

Specifically, the control section 18 monitors the output signals of the first sensor 42a, the second sensor 42b, and the third sensor 42c, and detects presence/absence of the rotational operation on the operation section 20, a rotation direction, a rotation speed, and presence/absence of the pressing operation on the operation section 20, based on switching between ON and OFF of the output signals (see FIGS. 10 and 13). Furthermore, the control section 18 detects coordinates of a position touched by a player on the touch pad 53 (coordinates of a touched position), in accordance with the output signal of the touch pad 53. Then, the control section 18 changes a screen image displayed by the liquid crystal display panel 52 of the display device 50, in accordance with one of the presence/absence of the rotational operation, the rotation direction, the rotation speed, the presence/absence of the pressing operation, and coordinates of the touched position on the touch pad 53, which have been detected as above.

Furthermore, the control section 18 controls a color of light emitted from the light-emitting section 42d, switching between a lightened state and a blinking state of the light-emitting section 42d, a time interval for blinking of the light-emitting section 42d etc., in accordance with one of the presence/absence of the rotational operation, the rotation direction, the rotation speed, the presence/absence of the pressing operation, and coordinates of the touched position on the touch pad 53. For example, the control section 18 may control emission of the light-emitting section 42d so that the interval for blinking is shorter as the rotation speed is higher. Furthermore, in a case where the light-emitting section 42d includes a light-emitting element capable of emitting light of multiple colors, the control section 18 may change a color of light emitted from the light-emitting section 42d, in accordance with the presence/absence of the rotational operation, the rotation direction, the rotation speed, and the presence/absence of the pressing operation.

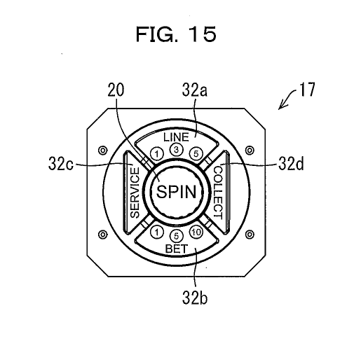

FIG. 15 is a view illustrating examples of screen images displayed by the operation unit 17 in a case where a player plays a slot game. The display device 50 of the operation unit 17 displays, (i) below the first opening region 32a, buttons for determining the number of lines (“1”, “3”, and “5” in FIG. 15), (ii) below the second opening region 32b, buttons for determining the number of bets (“1”, “5”, and “10” in FIG. 15), (iii) below the third opening region 32c, a service button for calling a staff, and (iv) below the fourth opening region 32d, a collect button for settlement. Furthermore, below the operation section 20, a word “SPIN” for urging a player to input an instruction (make a pressing operation) for starting rotation of reels. Here, the service button and the collect button are displayed on the third opening region 32c and the fourth opening region 32d which are relatively less easy to use for a player. This is intended for preventing a player from mistakenly touching the service button or the collect button.

The control section 18 determines the number of lines and the number of beds in accordance with the touching operation on buttons for determining the number of lines and buttons for determining the number of beds.

In a case where the control section 18 detects the pressing operation on the operation section 20, the control section 18 starts rotation of reels on the display region, and causes the display device 50 to display a presentation screen image indicating that the reels are now rotating.

As described above, the operation unit 17 in accordance with one or more embodiments of the present invention allows a player to make setting of the slot game and to enter an instruction for starting the slot game only by viewing the operation unit 17, so that the player is hardly required to move his/her eyes. Furthermore, the player can easily operate the operation unit 17 only with a single hand.

Some slot machines allow a player to play not only a slot game but also various mini games, and display various information to the player. In a case of such a slot machine, a player can play a mini game or review various information displayed by the liquid crystal display device 13 by operating the operation unit 17 while viewing the liquid crystal display device 13 provided on the reel display region 11. Furthermore, since the slot machine 1 in accordance with one or more embodiments of the present invention is designed such that the operation unit 17 includes the display device 50, the slot machine 1 may allow a player to play a mini game only with the operation unit 17 without using the reel display region 11. A specific example will be provided below.

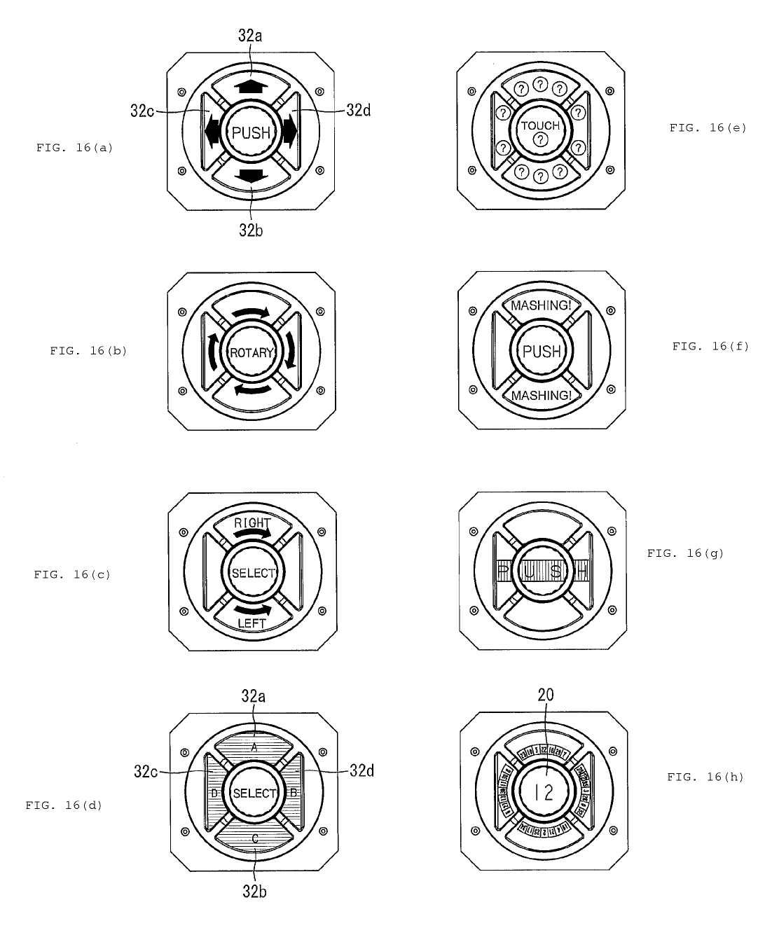

FIGS. 16(a)-16(h) are views illustrating other examples of screen images displayed by the operation unit 17. FIGS. 16(a)-16(c) illustrate examples of screen images displayed by the operation unit 17 in a case of urging a player to enter an instruction to move a moving target such as a cursor and a focus frame displayed by the liquid crystal display device 13 of the reel display region 11.

FIG. 16(a) illustrates an example of a screen image for urging a player to enter an instruction to move the moving target such as a cursor and a focus frame upward, downward, rightward, or leftward. As illustrated in FIG. 16(a), input buttons for entering instructions to move the moving object upward, downward, rightward, and leftward, respectively, are displayed on corresponding positions of the first to fourth opening regions 32a to 32d. In a case where one of these input buttons is touched, the control section 18 changes display on the reel display region 11 (liquid crystal display device 13) in accordance with the moving instruction displayed on the touched position. In a case where the control section 18 detects that the pressing operation is made on the operation section 20, the control section 18 determines that an item selected by the moving object at the time of the detection is to be executed, and causes the display device 50 to display a screen image corresponding to the determined item. For example, in a case where a mini game is selected, the control section 18 causes the display device 50 to change a screen image to one for playing the mini game.

FIGS. 16(b)-16(c) illustrate examples of screen images for urging a player to enter an instruction to rotate (make a rotational operation on) a moving target such as a cursor and a focus frame. In a case where the control section detects the rotational operation on the operation section 20, the control section 18 also changes a rotation speed of the moving target displayed by the reel display region 11 (liquid crystal display device 13), in accordance with a rotation speed of the operation section 20. In a case of FIG. 16(c), the control section 18 also changes a rotation direction of the moving target displayed by the reel display region 11 (liquid crystal display device 13), in accordance with a rotation direction of the operation section 20. In a case where the control section 18 detects that the pressing operation is made on the operation unit 20, the control section 18 determines that an item selected by the moving object at the time of the detection is to be executed, and causes the display device 50 to change a screen image to one corresponding to the determined item.

FIG. 16(d) illustrates an example of a screen image indicating selection items on the first to fourth opening regions 32a to 32d, respectively, of the operation unit 17. In a case where the control section 18 detects the touching operation on the touch panel 51, the control section 18 determines a selection item at the touched position as a selection candidate. In a case where the control section 18 detects that the pressing operation is made on the operation section 20, the control section 18 determines that the item selected at the time of the detection is to be executed, and causes the display device 50 to change a screen image to one corresponding to the determined item.

FIG. 16(e) illustrates an example of a screen image indicating a multiple of selection items at the first to fourth opening regions 32a to 32d of the operation unit 17. In a case where the control section 18 detects the touching operation on the touch panel 51, the control section 18 determines that the selection item at the touched position is to be executed.

FIG. 16(f) illustrates an example of a screen image which urges a player to repeatedly make the pressing operation on (hit repeatedly; button-mashing) the operation section 20. In a case where the control section 18 detects the pressing operation on the operation section 20, the control section 18 causes the display device 50 to change a screen image to one corresponding to the number of the detected pressing operation. For example, the control section 18 makes a presentation control such that as the number of the pressing operation is larger, the number of blinking of the word “hit repeatedly!” is larger, or the display device 50 displays an image with higher luminance.

FIG. 16(g) illustrates an example of a screen image which urges a player to make the pressing operation on the operation section 20. As illustrated in FIG. 16(g), the display device 50 is divided by the dividing section 32 into a plurality of opening regions, but may display a screen image which is a single image constituted by whole regions.

FIG. 16(h) illustrates an example of a screen image of the operation unit 17 in a case where a mini game (roulette) is played. As illustrated in FIG. 16(h), an image indicating a roulette wheel is displayed around the operation section 20. In a case where the control section 18 detects the rotational operation on the operation section 20, the control section 18 causes a mark (circle in the drawing) on the numbers on the roulette wheel to rotate, in accordance with the rotation direction and the rotation speed of the rotational operation. In a case where the control section 18 detects the pressing operation on the operation section 20, the control section 18 causes the display device 50 to change the screen image in such a manner that rotation of the mark is stopped. Furthermore, the control section 18 causes the display device 50 to display the number in such a manner that the number is superimposed with the mark and is displayed in a larger size at the region below the operation section 20. Thus, the slot machine 1 can cause the operation unit 17 to be presented as roulette. A player can play a mini game (roulette game) only by viewing the operation unit 17 without viewing the reel display region 11 of the slot machine 1.

### (Modifications)

### (First Modification)

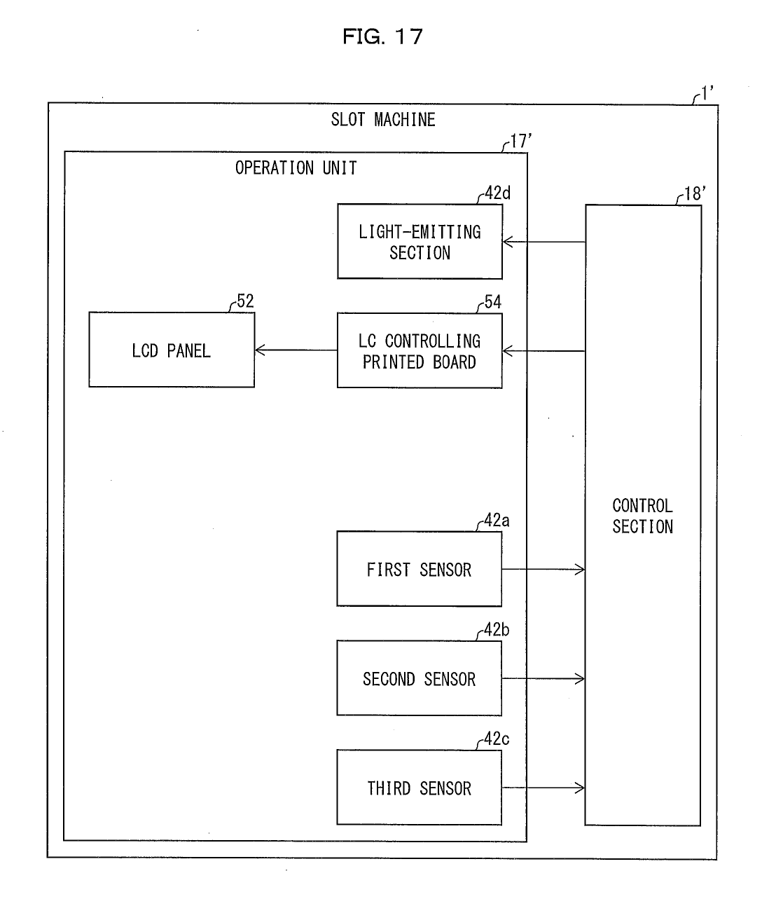

A description was made above as to a case where the display device 50 includes a touch panel 51 having a display function and an input function. However, the display device 50 may be arranged in such a manner that the display device 50 includes, instead of the touch panel 51, only a liquid crystal display panel 52 having no input function, and the display device 50 does not include the touch pad 53. That is, the game machine according to one or more embodiments of the present invention may be one including an operation unit which receives, as a player's operation, only a rotational operation and a pressing operation. FIG. 17 is a block diagram illustrating an internal configuration regarding a presentation control of a slot machine 1′ in a case where the display device 50 does not include the touch pad 53.

As illustrated in FIG. 17, the slot machine 1′ is different from the slot machine 1 illustrated in FIG. 14 in that the slot machine 1′ includes a control section 18′ instead of the control section 18 and includes, instead of the operation unit 17, an operation unit 17′ which does not include the touch pad 53.

In the modification illustrated in FIG. 17, the control section 18′ causes the liquid crystal display panel 52 to change a screen image to be displayed by the liquid crystal display panel 52, in accordance with a rotational operation and a pressing operation which have been detected based on output signals of the first to third sensors 42a to 42c.

For example, in a case of a screen image illustrated in FIG. 16(a), the control section 18′ causes one of items displayed at the first to fourth opening regions 32a to 32d (here, “upper”, “lower”, “left”, and “right”) which one is a selection candidate to be different in display form (e.g. color) from other items. When the control section 18′ detects a pressing operation, the control section 18′ determines that the item having been selected as the selection candidate is selected, and causes a screen of the liquid crystal display panel 52 to display an image corresponding to the determined item. In FIG. 16(d) and FIG. 16(e), similar processes may be carried out.

As described above, also in a case where the display device 50 does not have a touching operation function, a player is only required to operate the operation unit 17, so that the player is required to move his/her hands and eyes in a smaller range for operation, resulting in higher operability. Furthermore, since the control section 18′ causes the liquid crystal display panel 52 to change a screen image to be displayed by the liquid crystal display panel 52 in accordance with a rotational operation and a pressing operation, it is possible to make a presentation of the liquid crystal display panel 52 in various manners. This enhances a presentation effect of the operation unit 17′.

### (Second Modification)

A description was made above as to a case where the rotational operation on the main body 22 of the operation section 20 is made around an axis normal to the screen of the display device 50. Alternatively, the axis X of the operation section 20 may be inclined by a predetermined angle (e.g. 5° or 10°) with respect to a direction normal to the screen of the display device 50, in consideration of a place where the operation unit 17 is provided and player's operability of the operation unit 17.

### (Third Modification)

A description was made above as to a case where the output signals of the first to third sensors 42a to 42c change in accordance with both of the rotational operation and the pressing operation on the operation section 20. That is, each of the first to third sensors 42a to 42c doubles as a rotational operation sensor whose output signal changes in accordance with the rotational operation and a pressing operation sensor whose output signal changes in accordance with the pressing operation.

Alternatively, a rotational operation sensor whose output signal changes in accordance with the rotational operation and a pressing operation sensor whose output signal changes in accordance with the pressing operation may be provided separately.

For example, the second wall section 24e may be designed to have a small height so that the pressing operation causes only the protrusions 24f to enter the object-detecting space formed by the first to third sensors 42a to 42c as illustrated in FIG. 9. Furthermore, the operation section 20 and the lower cover section 40 may be provided with respective electrodes which touch each other only when the pressing operation is made on the operation section 20. In this case, the respective electrodes provided on the operation section 20 and the lower cover section 40 each serve as a pressing operation sensor whose output signal changes in accordance with the pressing operation, and the first to third sensors 42a to 42c each serve as a rotational operation sensor whose output signal changes in accordance with the rotational operation.

### (Other Modification)

The operation units 17 and 17′ may include, instead of the liquid crystal display panel 52, one of various display panels such as a plasma display panel and an organic EL (electroluminescence) display panel.

As described above, a slot machine (game machine) 1 in accordance with one or more embodiments of the present invention includes an operation unit 17 via which a player enters an operation. The operation unit 17 includes: a liquid crystal display panel 52; an operation section 20 provided on a screen of the liquid crystal display panel 52; a frame section (support section) 30 and a lower cover section (support section) 40 for supporting the operation section 20 in such a manner that the operation section 20 is rotatable and the operation section 20 is capable of being pressed toward the liquid crystal display panel 52; and first to third sensors 42a to 42c each for outputting a signal corresponding to a rotational operation on the operation section 20 or a signal corresponding to a pressing operation on the operation section 20.

The first to third sensors 42a to 42c are used not only as rotational operation sensors each for outputting a signal corresponding to a rotational operation but also as pressing operation sensors for outputting a signal corresponding to a pressing operation.

The slot machine 1 further includes a control section 18 for causing the liquid crystal display panel 52 to change a screen image to be displayed by the liquid crystal display panel 52, in accordance with at least one of (i) a rotational operation detected based on the signal outputted from each of the first to third sensors 42a to 42c, and (ii) a pressing operation detected based on the signal outputted from each of the first to third sensors 42a to 42c.

With the arrangement, the slot machine 1 can receive various input instructions only via the operation unit 17 in accordance with the rotational operation and the pressing operation. Furthermore, the slot machine 1 can cause the liquid crystal display panel 52, which is a part of the operation unit 17, to display a screen image for urging a player to make an operation. Consequently, the slot machine 1 enables the player to make an operation while moving his/her hands and eyes in a smaller range, so that the slot machine 1 has higher operability.

Furthermore, since the control section 18 changes a screen image displayed by the liquid crystal display panel 52 in accordance with at least one of the rotational operation and the pressing operation, it is possible to make various kinds of presentations of the liquid crystal display panel 52. Consequently, it is possible to enhance a presentation effect of the operation unit 17.

The slot machine 1 in accordance with one or more embodiments of the present invention may be arranged such that the operation unit 17 further includes a light-emitting section 42d, and the control section 18 controls emission of the light-emitting section 42d in accordance with at least one of a rotational operation and a pressing operation. With the arrangement, it is possible to further enhance a presentation effect of the operation unit 17.

The slot machine 1 in accordance with one or more embodiments of the present invention may be arranged such that the operation section 20 is configured in such a manner that the screen of the liquid crystal display panel 52 below the operation section 20 is visible from above the operation section 20. With the arrangement, a part of the screen of the liquid crystal display panel 52 which part is right below the operation section 20 can be also used for presentation. For example, by displaying, below the operation section 20, an item indicative of a function which operates in response to the pressing operation, it is possible to urge a player to make the pressing operation.

The slot machine 1 in accordance with one or more embodiments of the present invention may be arranged such that the control section 18 causes the liquid crystal display panel 52 to change a screen image to be displayed by the liquid crystal display panel 52, in accordance with at least one of a rotation speed and a rotation direction of the operation section 20, which have been detected based on the signal outputted from each of the first to third sensors 42a to 42c. Furthermore, the slot machine 1 in accordance with one or more embodiments of the present invention may be arranged such that the control section 18 changes emission of the light emitting section 42d, in accordance with at least one of the rotation speed and the rotation direction of the operation section 20. With the arrangement, it is possible to further enhance a presentation effect.

As described above, a game machine according to one or more embodiments of the present invention is a game machine, including an operation unit via which a player enters an operation, the operation unit including: display section; an operation section provided on a screen of the display section; a support section for supporting the operation section in such a manner that the operation section is rotatable and the operation section is capable of being pressed toward the display section; at least one rotational operation sensor for outputting a signal corresponding to a rotational operation on the operation section; and at least one pressing operation sensor for outputting a signal corresponding to a pressing operation on the operation section, and a control section for causing the display section to change a screen image to be displayed by the display section, in accordance with at least one of (i) a rotational operation detected based on the signal outputted from said at least one rotational operation sensor, and (ii) a pressing operation detected based on the signal outputted from said at least one pressing operation sensor.

With the arrangement, the game machine can receive various input instructions only via the operation unit in accordance with the rotational operation and the pressing operation. That is, a player can enter various instructions only by operating the operation unit. Furthermore, the game machine can cause the display section, which is a part of the operation unit, to display a screen image for urging a player to make an operation. Consequently, the game machine enables the player to make an operation while moving his/her hands and eyes in a smaller range, so that the game machine has higher operability. Furthermore, since the control section changes a screen image displayed by the display section in accordance with at least one of the rotational operation and the pressing operation, it is possible to make various kinds of presentations of the display section. Consequently, it is possible to enhance a presentation effect of the operation unit. As a result, it is possible to provide a game machine with high operability and a high presentation effect.

According to one or more embodiments of the present invention, the game machine is arranged such that the operation unit further includes a light-emitting section, and the control section controls emission of the light-emitting section in accordance with at least one of (i) a rotational operation detected based on the signal outputted from said at least one rotational operation sensor, and (ii) a pressing operation detected based on the signal outputted from said at least one pressing operation sensor. With the arrangement, it is possible to further increase a presentation effect of the operation unit.

A game machine according to one or more embodiments of the present invention is arranged such that the operation section is configured in such a manner that the screen of the display section below the operation section is visible from above the operation section.

With the arrangement, a part of the screen of the display section which part is right below the operation section can be also used for presentation. For example, by displaying, below the operation section, an item indicative of a function which operates in response to the pressing operation, it is possible to urge a player to make the pressing operation.

A game machine according to one or more embodiments of the present invention is arranged such that the control section causes the display section to change a screen image to be displayed by the display section, in accordance with at least one of a rotation speed and a rotation direction of the operation section, which have been detected based on the signal outputted from said at least one rotational operation sensor. Furthermore, the game machine according to one or more embodiments of the present invention may be arranged such that the control section changes emission of the light emitting section, in accordance with at least one of a rotation speed and a rotation direction of the operation section, which have been detected based on the signal outputted from said at least one rotational operation sensor. With the arrangement, it is possible to further increase a presentation effect.

A game machine according to one or more embodiments of the present invention is arranged such that said at least one rotational operation sensor are configured to also serve as said at least one pressing operation sensor. With the arrangement, it is possible to prevent an increase in the number of members.

The present invention is not limited to the description of the embodiments above, but may be altered by a skilled person within the scope of the claims. An embodiment based on a proper combination of technical means disclosed in different embodiments is encompassed in the technical scope of the present invention.

One or more embodiments of the present invention is applicable to game machines including an operation unit via which a player enters an operation, such as slot machines, pachinko machines, and various game machines.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

### REFERENCE SIGNS LIST

1, 1′ Slot machine (game machine)
17, 17′ Operation unit
18, 18′ Control section
20 Operation section
22 Main body
23 Bearing
24 Bearing fixing section
24c Operation-detecting member
24e Second wall section
24f Protrusions
25 Case
30 Frame section (support section)
32a First opening region
32b Second opening region
32c Third opening region
32d Fourth opening region
40 Lower cover section (support section)
42a First sensor (rotational operation sensor, pressing operation sensor)
42b Second sensor (rotational operation sensor, pressing operation sensor)
42c Third sensor (rotational operation sensor, pressing operation sensor)
42d Light-emitting section
50 Display device
51 Touch panel (display section)
52 Liquid crystal display panel (display section)

1. A game machine, comprising:
an operation unit that accepts an operation from a player, comprising:
a display section,
an operation section disposed on a screen of the display section,
a support section that rotatably supports the operation section such that the operation section can be pressed toward the display section,
at least one rotational operation sensor that outputs a signal corresponding to a rotational operation on the operation section, and
at least one pressing operation sensor that outputs a signal corresponding to a pressing operation on the operation section, and
a control section that causes the display section to change a screen image to be displayed by the display section, in accordance with at least one of:
a rotational operation detected based on the signal outputted from said at least one rotational operation sensor, and
a pressing operation detected based on the signal outputted from said at least one pressing operation sensor.

2. The game machine as set forth in claim 1,
wherein the operation unit further comprises a light-emitting section, and
wherein the control section controls emission of the light-emitting section in accordance with at least one of:
a rotational operation detected based on the signal outputted from said at least one rotational operation sensor, and
a pressing operation detected based on the signal outputted from said at least one pressing operation sensor.

3. The game machine as set forth in claim 1, wherein the screen of the display section below the operation section is visible from above the operation section.

4. The game machine as set forth in claim 1, wherein the control section causes the display section to change a screen image to be displayed by the display section, in accordance with at least one of a rotation speed and a rotation direction of the operation section, which have been detected based on the signal outputted from said at least one rotational operation sensor.

5. The game machine as set forth in claim 2, wherein the control section changes emission of the light emitting section, in accordance with at least one of a rotation speed and a rotation direction of the operation section, which have been detected based on the signal outputted from said at least one rotational operation sensor.

6. The game machine as set forth in claim 1, wherein said at least one rotational operation sensor are configured to also serve as said at least one pressing operation sensor.
